(19) United States
(12) Patent Application Publication
(10) Pub. No.: US 2014/0012929 A1
(43) Pub. Date: Jan. 9, 2014

(54) DELIVERING MESSAGES OVER MULTIPLE COMMUNICATION PATHS

(71) Applicant: Life of Two, San Francisco, CA (US)

(72) Inventor: Bianca Weishaupl, San Francisco, CA (US)

(73) Assignee: Life of Two, San Francisco, CA (US)

(21) Appl. No.: 13/918,696

(22) Filed: Jun. 14, 2013

Related U.S. Application Data
(60) Provisional application No. 61/660,638, filed on Jun. 15, 2012.

(51) Int. Cl. H04L 12/58

(52) U.S. Cl. CPC H04L 51/04
USPC 709/206

(57) ABSTRACT

Disclosed herein are systems, methods, and non-transitory computer-readable storage media for delivering a message to one or more recipients over multiple data communication paths.

### CROSS-REFERENCES TO RELATED APPLICATIONS

This application is a claims priority to U.S. Application No. 61/660,638, entitled “A SYSTEM AND METHOD FOR DELIVERING A SINGLE MESSAGE TO ONE OR MORE RECIPIENTS OVER MULTIPLE COMMUNICATION PATHS”, filed Jun. 15, 2012, of which the full disclosure of this application is incorporated herein by reference for all purposes.

### BACKGROUND

1. Technical Field

The present disclosure relates to the transmission of messages and more specifically to transmitting messages over multiple communication paths.

2. Introduction

In a social networking environment, relationships of all kinds are built and encouraged. Family relationships, spouse, children, parents and siblings all come to represent an inner circle of intimacy. The ability to interact with different types of friends and family is also very important. However, cloud-based social networking systems lack a variety of communication methods, but utilize different connection methods. For example, users can access a social media platform using a smartphone, a tablet computer, a laptop or a desktop computer. Other social networking platforms cater to smartphone users and can utilize SMS messaging or can set a maximum number of characters for messages.

Some systems can receive failure messages and the ability to resend messages using other communication channels that were not first attempted, however, the alternative channels can be inconvenient to access or simply unavailable to a user.

When two people are well connected they might want to try many ways to reach each other. If one way fails then a user is forced to manually go through several different methods for reaching the other person. After some time they might forget which methods were tried and re-try the same ones that have already failed to solicit a response. Most of the time these communication paths do not return an error; rather a buffering system can hold the message or the user is too busy to notice. Also, the alternative delivery system might be set to ignore a delivery attempt. For example, a user's smartphone could be set to silent for a given alternative delivery method.

Another problem is that smartphones and other devices can have several different connection methods available to them. These can include physical Ethernet, WiFi, Wide Area Wireless like GSM/CDMA/EDGE/UMTS/LTE and other 4G networks and even PSTN dial up alternatives. Yet there are no services that can make use of all these connection options. What is needed is a way of automatically locating and using addressing methods for commonly used social networking sites.

Also what is needed is advanced methods that allow users multiple ways to reach-out and communicate and for providing multiple communication paths to users in a complex networking environment. This needed solution should take advantage of highly-connected individuals with a plethora of communication methods. This solution should not require manual attempts to resend the same message just to get a response from another person or persons.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for providing access to a multi-path send commands between two or more people that are trying to reach each other.

Some embodiments of the present technology involve a messaging application module transmitting a message over a communication path from a first electronic device to a second electronic device and determining the message has not been responded to, for example, by determining that a response is not received within a predetermined threshold time period. The messaging module can identify additional communication paths from the first electronic device to the second electronic device re-transmitting the message over an additional communication path.

In some embodiments the messaging module can send, or ““blast”” messages via every additional communication path. In some embodiments the messaging module can serially re-transmit the message to over additional communication paths according to a progression list until a response is received. The progression list can be manually ordered, ordered based on relative speeds of the communication paths, order based on a cost associated with using the communication paths, etc.

In some embodiments the messaging module can establish a log of messaging transaction performed between devices. The log can reflect the frequency that each communication path in is used to perform messaging transactions between the first electronic device and the second electronic device and the progression list can be ordered based on the frequencies specified in the log.

In some embodiments the messaging module can receive an instruction to initiate a voice communication session between devices over one or more of a cellular communication path, a voice over Internet protocol (VoIP) communication path, and an audio-visual communication path. In some embodiments the messaging module can receive an instruction to search one or more social network platforms for an account associated a friend, family, or other contact. If a profile is found, a communication path associated with the social network platform is recorded and can be used for future message delivery.

The multi-path send command can be used for fun or in desperate times when trying to reach someone that is unreachable or in an emergency. In a rich data communication setting where two or more people have two or more methods for reaching each other the invention provides a method for pushing the same message across all known communication paths. This is possible because one person might have connections to several different social networks, multiple email addresses, one or more smartphones, a tablet device, a television that is connected to the Internet and many other possible communication centers. When two or more people are well connected, especially if they are close family members like husband, wife and children, they share all these communication paths with each other to ensure they are easily reachable.

The solution provides a method for gathering communication methods and addressing information for one or more people. The solution also provides a method for prioritizing, selecting, editing and adding to the communication methods. Finally the solution provides a single button that can be selected to send an entered message through all configured and selected communication paths. The solution also discloses the ability to search commonly used social networking sites, business sites, personal contact clouds and other future public information caches to find other addressing methods for reaching individuals. Such sites as Facebook™, Twitter™, LinkedIn™ and others can be used to build many additional communication paths. Information will be gathered from these sites and added to existing addressing information to further extend the number of communication methods to be used to reach people.

As used herein, the term communication method can cover both physical communication methods and logical address-based communication methods for reaching people. In communication specific terms these are different layers in the communications protocol hierarchy but in terms of reaching another person both these levels are paramount for a message to be transmitted between end points.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system for providing multiple communication paths to users linked together in a network according to some embodiments of the present technology;

FIG. 2 illustrates an exemplary user record interface 40 for configuring an application that provides multiple communication paths to users linked together according to some embodiments of the present technology;

FIG. 3 illustrates an exemplary messaging interface according to some embodiments of the present technology;

FIG. 4 illustrates an exemplary status interface according to some embodiments of the present technology;

FIG. 5 illustrates an exemplary status interface message 116 that can be displayed when a “blast” message selection is made according to some embodiments of the present technology;

FIG. 6 illustrates additionally interface items for selecting communication paths according to some embodiments of the present technology;

FIG. 7 illustrates an exemplary messaging interface after a message “blast” according to some embodiments of the present technology;

FIG. 8 illustrates an exemplary method of sending a “blast” message according to some embodiments of the present technology; and

FIG. 9A and FIG. 9B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

A system, method and non-transitory computer-readable media are disclosed which allow users multiple ways to reach-out and communicate and for providing multiple communication paths to users in a complex networking environment.

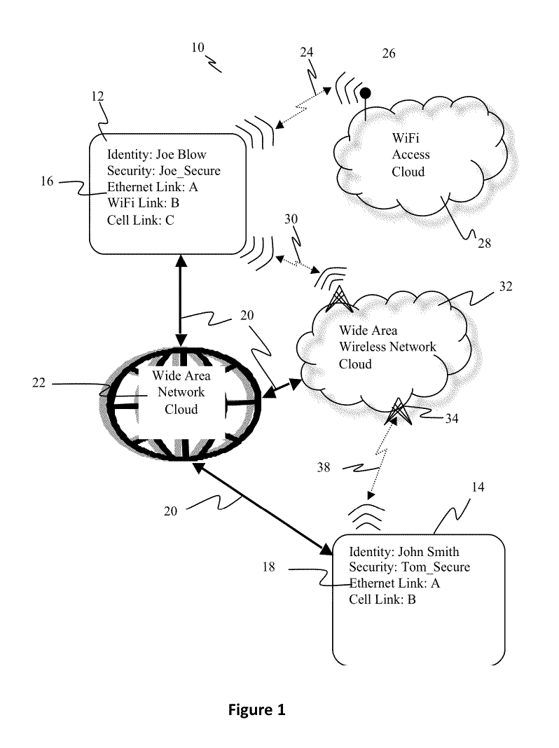

FIG. 1 illustrates an exemplary system for providing multiple communication paths to users linked together in a network according to some embodiments of the present technology.

As shown in FIG. 1, a network 10 includes two potential correspondents 12, 14 connecting into one or more data communication systems. One correspondent 12 is connected into three networks 22, 32, 28, while the other 14 is connected into just two networks 22, 32. With current and future computing technology, most smartphones, tablets, laptops and network computers have a wide range of connection strategies. For example, computer 1 (12) can connect into three networks 22, 28, 32 that include a connection 20 into a wire-based wide area network like the Internet 22. These devices can also connect with networks via WIFI 24 to a high-speed network 28 and a wireless link 30 into a wide-area wireless network 32 like GSM/GPRS/EDGE/UMTS or LTE network. As shown in FIG. 1, the second computer 14 has a wireless connection 38 through a wide area network carrier 32 and they also have land-line connection 20 into a wide area network 22.

With many connections there are also many possible addressability choices for each computer system 12, 14. Some of these include an Internet IP address assigned through Ethernet 20 either fixed or variable and if necessary the address is discoverable through DHCP. There could also be a second IP address via the WIFI link 24 it has to a local access point 26. There could also be a phone number address (E.164 address) on the wireless wide-area network 32 that can be reached via SMS or MMS messaging and phone calls.

Above these lower layer addresses are would be a set of higher level addresses. Some of these additional addresses include a BlackBerry Messenger (BBM) PIN address over the wireless network, a series of email addresses that can live in the land-line global network and a series of proprietary social network addresses like Facebook, Twitter, Linked-In, Skype, and many others. These social network solutions run over wide-area networks like the Internet but have their own naming and addressing schemes for their user base. Through all these connection types and social networking services the user can exchange a wide range of credentials. For one skilled in the art the exchange of login and password information, personal information and confidential items is well known. Shown within computer systems 12, 14 are a small set of credentials and configured connection items 16, 18. As a small sample there is the shared identification name, a security value, perhaps like a public/private key pair and there are a series of link identifiers. Each link identifier can include link address, network address, state information and protocol details.

With the new public nature of social network sites and our person profile it is also possible for the software on a computer to seek out public profiles for people we wish to communicate with. In building all known communication methods it is also possible to construct a wider list and go beyond the specific messages that have been received to date from one person. When multiple physical communication paths are available this could even lend itself to looking in different wide-area networks. The software could look within a company-specific wide-area network, accessible only through WIFI or Ethernet within the company's LAN or VPN link.

Linked users can deliver messages over the multiple communication paths. Indeed, some embodiments of the present technology involve automatically sending a message through an alternative communication path after a first path fails to deliver the message.

Similarly, some embodiments of the present technology involve sending messages through alternative communication paths if a sender signifies a heightened importance of a particular message. For example, an SMS message sent to a spouse's smartphone can be also sent to all of the spouse's messaging applications, email, social media newsfeeds, etc. if the message is marked as “Urgent”. Also, the message can be sent to other people if it is marked with a high level of importance. For example, a message can be sent to an intended recipient and nearby relatives or friends if the message is marked as “Emergency.” In the business environment, a message can be sent a worker and his secretary if it is marked as “ASAP.”

In some other embodiments, a messaging module can imply that the recipient of a message has not viewed the message or has viewed the message, but is not preparing a response. For example, the messaging module can examine whether a threshold time has passed since the transmission of the message. Similarly, the messaging module can examine a history of messaging between users and determine that an atypical amount of time has passed since the transmission of the message. Some embodiments involve a combined analysis involving examining the history of messaging, determining that an atypical amount of time has passed with no response since the transmission of the message, and waiting another threshold amount of time before sending the message via alternative communication paths.

Some embodiments of the present technology involve message ““blasting” which involves sending a message to an intended recipient through a plurality or through all communication paths between linked users.

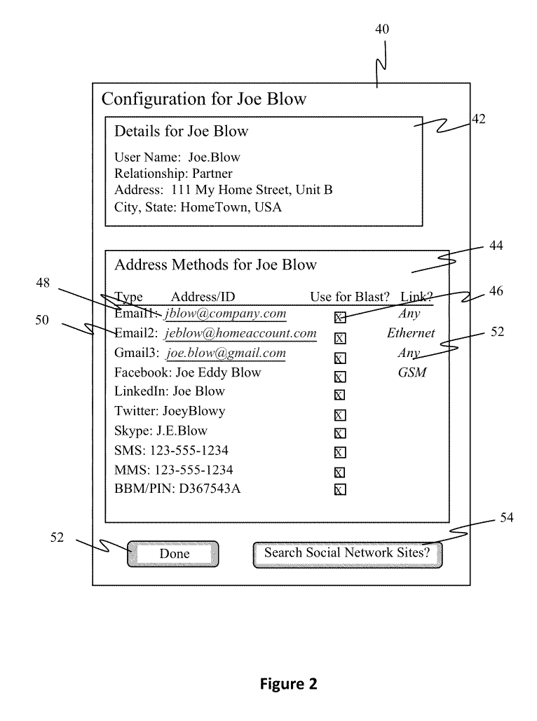

Some embodiments of the present technology involve a messaging application module configured to configure these messaging options. FIG. 2 illustrates an exemplary user record interface 40 for configuring an application that provides multiple communication paths to users linked together according to some embodiments of the present technology.

The system of FIG. 2 is an exemplary embodiment and for one skilled in the art of user interfaces it would be obvious that many different user interface methods could be used to collect and manage a similar set of data that is shown. For example in other embodiments this information might be kept directly in the address book or contact list. For simplicity this single screen interface 40 is shown for clarity.

As shown in FIG. 2, a user name of Joe Blow is shown with a relationship of partner 42. In some embodiments of the present technology, the messaging application module allows a user to characterize a variety of relationships such as partner, close family members, co-workers, etc. and the messaging application module can “blast” messages to a specified relationship class.

Each record of this type would have all the contact or address methods 44 for the user with an address type 50, so the address is used in the correct way. For example, an email address might be used directly with SMTP/POP protocols, all well understood mail centric methods. A Facebook address might first cause the software to connect Facebook over HTTP and then submit the necessary connection sequences to login to Facebook to send the message. Similar restrictions would exist with Twitter, BBM or other messaging protocols and types. In some embodiments it would also be possible to indicate which physical links to use when sending the message 52. In some cases the setting can be ‘ANY’ 52, which means to use any available and connected service. In some cases the user might want to use the fastest services like WIFI only or even have a preference list: Ethernet, WIFI and then GSM. The progression list indicates which might be the cheapest, fastest or more reliable to use. This could improve the speed of the message and its reliability. In many embodiments a physical hand-held device like a Smartphone has coverage within several different networks simultaneously. The GSM network might have ubiquitous coverage but is mostly saturated with other traffic. The WIFI link might be the more reliable link when it is available to the Smartphone.

There would also be the actual address value 50 for each address entered. After this field there would be a field to allow the “blast” message setting to be changed 46. For example, a user can turn off one or two of the different methods available and leave another four or five available for the “blast” message. Additionally, during the course of interacting with another person the user would be able to add more and more addressing methods. Over time the list could be added to as more and more commonly used messaging types are added to the Internet. In other exemplary embodiments when a new message exchange takes place between two users they are encouraged to dynamically add the new addressing type to the existing set of message types present. For example it would be possible to open a message and ask the user a question like: ‘update communication methods’? Then the software would find the user name that matches the incoming message and offer the option of updating it. This type of auto-populating is well known in the field of messaging.

Also illustrated is the ability to instruct the software to perform an Internet search on all well known social networking sites for public address information to add to the profile for this user 54. Such a button (touch screen or selectable menu item) might prompt the user with a ‘Please Wait’ kind of a screen while a search was performed on all available physical connections. Not shown in this figure would be a prompt for the user to accept or reject some or all of the addresses found for this user Joe Blow. When the user is done editing and working on this screen they would select Done 52 to return to their previous screen.

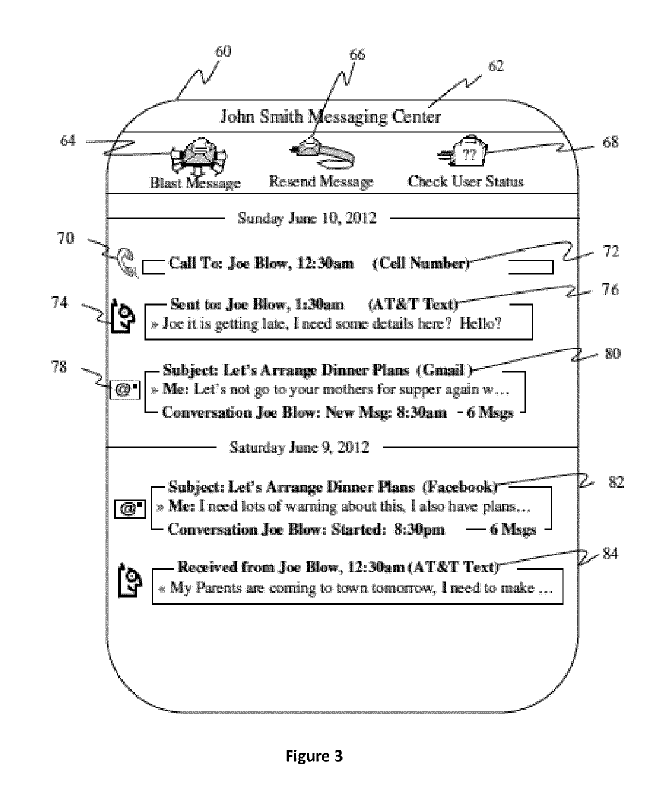

FIG. 3 illustrates an exemplary messaging interface according to some embodiments of the present technology. As shown in FIG. 3, a message view 60 is displayed of Joe Blow talking to John Smith. In this embodiment John Smith's messaging center 62 provides icons for sending a “blast” Message 64, Resending a Message 66 and Checking User Status 68. For one skilled in the art of user interfaces there could be several other embodiments of this screen 60. The presence of other similar message choices like ‘Cancel Message’, ‘Re-edit Message’, ‘Ping User’ and other such menus could provide additional tools to help the user get another person's attention.

At some point in the conversation it is clear that John loses his patience with Joe Blow 76 and he even decides to call Joe Blow 72. In this embodiment each different event shows an icon 70, 74, 78 to help at a quick glance see what has happened. This conversation thread started with Joe Blow sending a text message on AT&T 84 indicating his parents are coming to town and dinner was going to be planned. Because the plan is for tomorrow John Smith sends a Facebook™ message 82 requesting details of this planned dinner 82. After a day passes John Smith sends a Gmail Message 80 to Joe again asking for details soon. After several hours and that goes unanswered John Smith sends an AT&T Text message 76, followed by a phone call 72. When everything fails they decide to perform a Check Status 68.

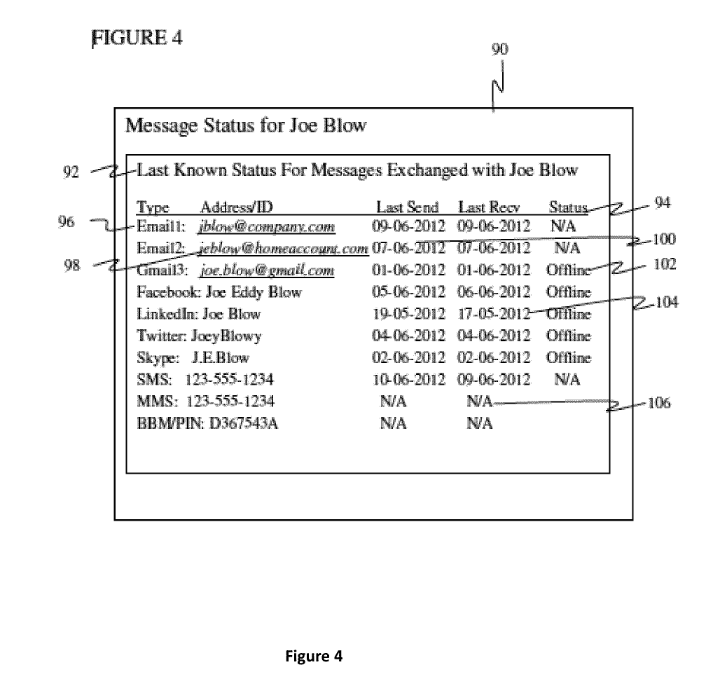

FIG. 4 illustrates an exemplary status screen interface 90 showing an messaging interaction with another person according to some embodiments of the present technology. Before performing a “blast” message the user might need to look at what exactly is going on. For one skilled in the art of data communications there might be many ways to understand why another person is unreachable. In some cases it doesn't matter as the reason to “blast” the message is more fun and silly. In other cases opening this screen might point out a pattern where the person to be reached never seems to respond to email, but is quick to respond to SMS. There are many other patterns that are possible, perhaps every day from nine to five they never respond to SMS, MMS and phone calls. This could indicate that the location where they work is out of coverage for their smartphone. These and other reasons might be the source of the problem.

In this embodiment the user is shown a title 92 indicating these are the last known status for different messaging methods known to the system. With each line there is a message type 96, the actual address value 98, a last sent value 100, a last received value 104 and a status 102. By showing the last sent 100 and last received message 104 the user that is about to perform the “blast” Message might adjust their thinking about how to reach them. Where possible in other social networks like Facebook™ it might be possible to retrieve the user's current ONLINE status 102 and display this as well. By showing these the user about to perform the “blast” Message might realize that perhaps the target user is ignoring them for some reason. In some cases it might be easy to see that in fact some communication methods are used very rarely like LinkedIn 104. The last time LinkedIn was used was a month ago. When a communication is configured but has never been used it might show a Not Applicable (N/A) 106.

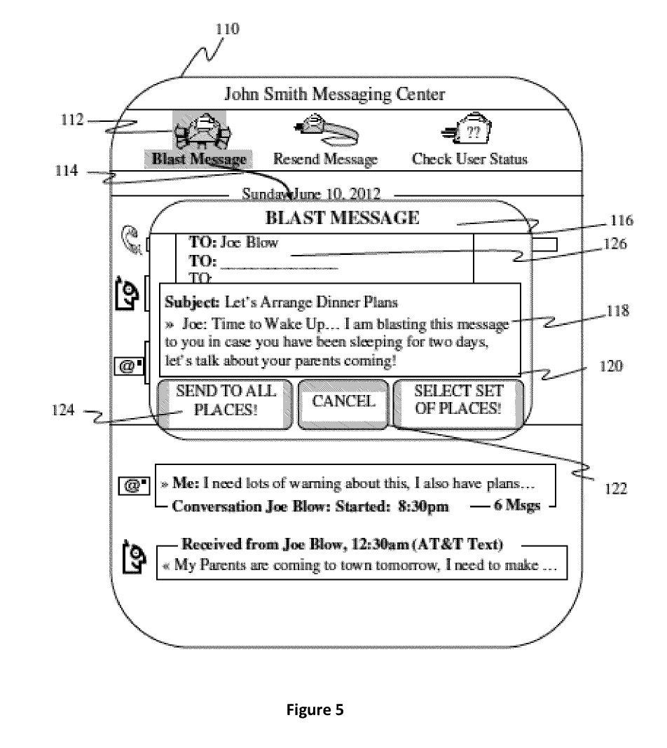

FIG. 5 illustrates an exemplary status interface message 116 that can be displayed when a ““blast”” message selection is made according to some embodiments of the present technology. For one skilled in the art it is clear that this could be implemented as either a pop-up message overlaying items that are already on the screen or it could be a dedicated screen. In this illustration the “blast” Message Icon and Label are highlighted 112 to indicate the user has selected the button. Selecting this using the input method available (touch screen, button, roller wheel, etc) causes 114 a pop-up screen to appear 116. The decision to select “blast” Message will vary in every circumstance. This could either be a fun wake-up call, or an urgent call for assistance.

This simplified example shows the “blast” message entered by John Smith 118 with a subject “Let's Arrange Dinner Plans”. This embodiment then provides actions to SEND TO ALL PLACES 124, CANCEL 122 and SELECT SET OF PLACES 120. This final option, to Select Set of Places 120 allows some last minute adjustments to which addressing methods are used. Perhaps the user performed the Check Status 120 step and has adjusted where they wish to try reaching the user.

For one skilled in the art of messaging it is also clear that it would be possible to enter one or more destination names to perform the “blast” message to 126. If the sender knows that Joe Blow has close association with a common group of friends the sender might want to perform a “blast” Message to a wider range of people 126. In this example the sender enters only Joe Blow 126 and leaves the additional TO fields blank.

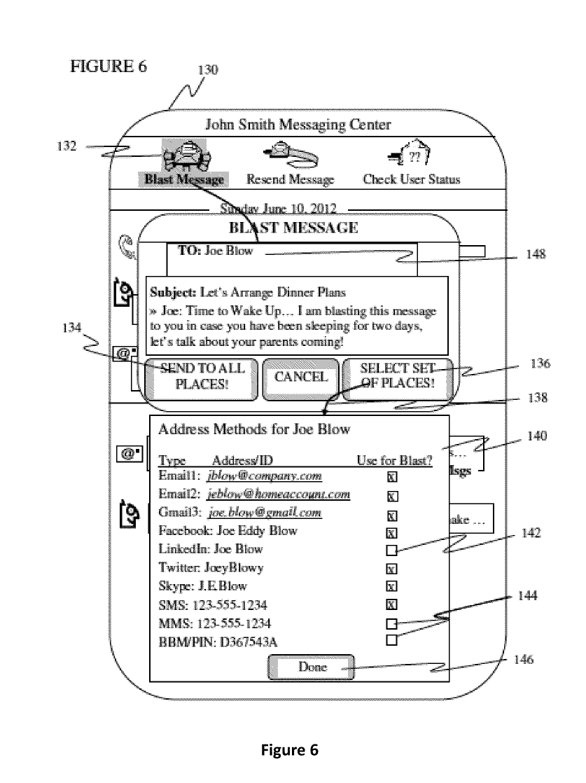

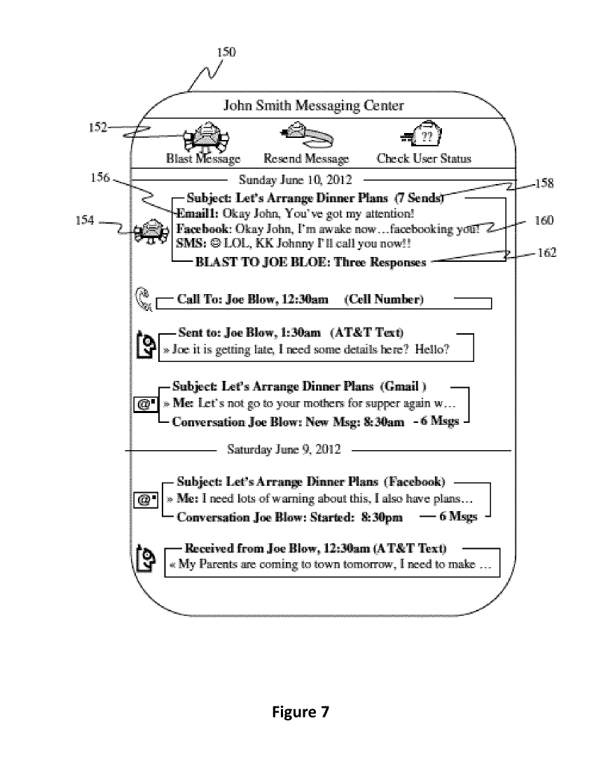

Turning now to FIG. 6 there is an illustration 130 showing a further adjustment of the set of places to send the message 140. In this example the user has selected the Select Set of Places button 136 and it has brought up 138 another pop-up box 140. In this new pop-up box there is a presentation of the current configuration setting for each communication path 142 for the designated addressees, in this example only Joe Blow 148. If there were multiple addressees then the address methods for each one could be presented one after the other until the user had edited all addressing method dialogue boxes. Each path has an X or a blank box 142 to indicate whether they will be used on the “blast” message or not. The user can then go through and adjust the check-boxes 142, 144 thus adjusting which communication paths they wish to use for this “blast” Message command. For example the user might have noticed in the Check Status screen that Joe Blow rarely uses LinkedIn 142 and they have never used MMS and BBM 144. So for these they clear the “X” and therefore these methods will not be used. Once they select Done 146 they will close the pop-up box and return to perform the SEND 134 command. This is difficult to show here but we assume the user has pressed SEND 134 and it changes the screen display as shown in FIG. 7.

Turning now to FIG. 7 there is an illustration of the resulting actions caused from performing the “blast” Message action. In this embodiment the “blast” Message 162 is shown inline with other messages sent and received with Joe Blow. In other embodiments it would be possible to have the “blast” Message and the resulting reply messages have its own dedicated interface. In this embodiment part of the original subject field is shown 158 and the total number of paths the message was sent out on (seven). The icon 154 matches the icon used to perform the “blast” Message originally 152. Within the text portion of the message 160 are the consolidated responses with the message type 156 shown in front of each received response. Based on the message 160 it appears Joe Blow took the “blast” Message as a joke and responded back through three different message paths 162. In some cases Joe Blow might have performed his own “blast” Message back to John Smith for a joke. In other cases Joe Blow might have been concerned or angry to have been bothered.

If the user wishes to see more of each response they can open a detailed message read box, not shown here. Such open message commands and resulting user interfaces are well known to those in the field of messaging. Depending on the context of the original “blast” Message the receiver might decide to send back five or ten reply messages just to have fun with the idea of being “blast”ed. In other more urgent contexts the receiver sends back a single reply that indicates they got the message and will call back immediately. The correlating of all reply messages into a single interface makes the managing of the possible result much easier for the user 160.

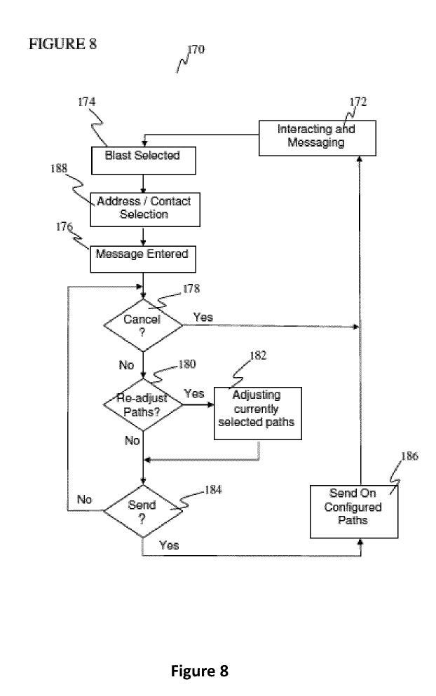

FIG. 8 illustrates an exemplary method of sending a ““blast”” message according to some embodiments of the present technology. Between any two correspondents normal interacting and messaging takes place 172. At some point in time the “blast” Message is selected 174. The user is also given the option to entering one or more addresses for the “blast” Message 188. By default the current user they are communicating with would be automatically placed into the TO field, but then additional names could be added if needed.

Eventually the message is entered 176 that will be used and the user has to select an action. Within this embodiment there are three menu items for the user to select and the software waits for the Cancel 178, Re-Adjust Paths 180 or the Send Command 184. If the user Cancels 178 out of the “blast” Message they return to the message screen to continue interacting and performing normal messaging 172. If the user decides to re-adjust the message paths 180 then the paths are adjusted to match exactly what they desire 182. If the user has selected send 184 the software will perform the send on all configured paths 186 and return to the main Interacting and Messaging screen 172.

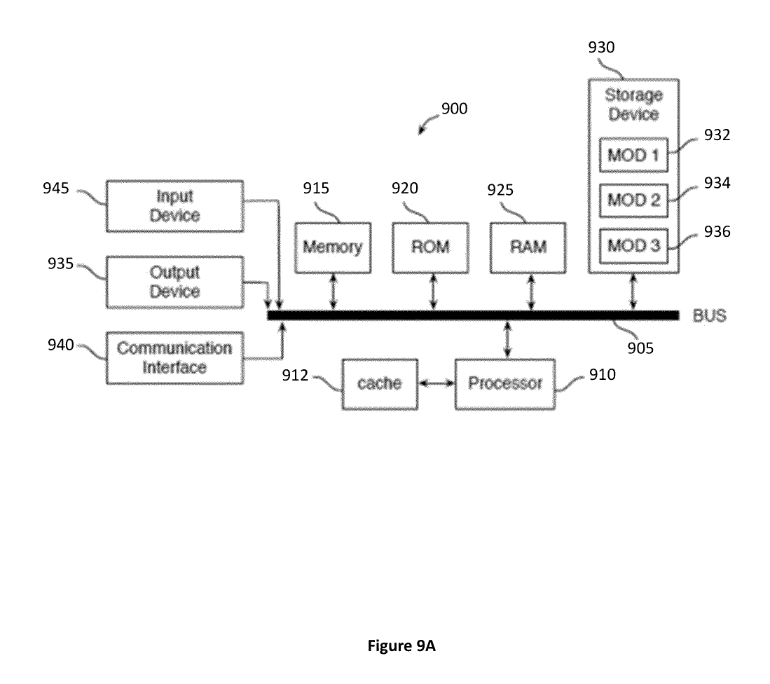

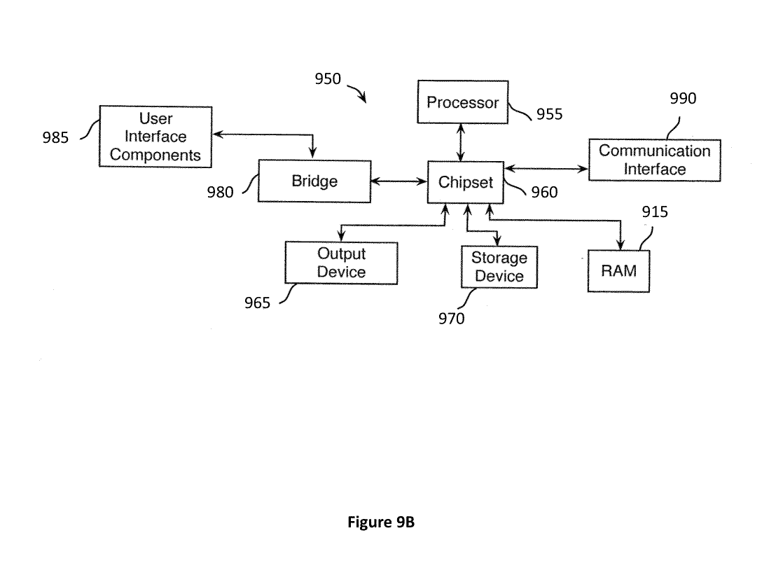

FIG. 9A and FIG. 9B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that exemplary systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. A computer-implemented method of exchanging messages between users comprising:
transmitting a message over a first communication path from a first electronic device to a second electronic device;
receiving an indication that a response to the message has not been received from the second electronic device;
identifying one or more additional communication paths from the first electronic device to the second electronic device; and
re-transmitting the message over an additional communication path.

2. The computer-implemented method of claim 1, further comprising:
identifying the additional communication path by accessing a user record on the first electronic device for a user associated with the second electronic device.

3. The computer implemented method of claim 1, further comprising:
receiving an instruction to send an additional message via each communication path in the plurality of additional communication paths.

4. The computer implemented method of claim 3, further comprising:
serially re-transmitting the message to over the one or more additional communication paths according to a progression list until a response is received.

5. The computer implemented method of claim 4, wherein the progression list is user-defined.

6. The computer implemented method of claim 4, further comprising:
ordering the progression list based on relative speeds of the communication paths in the plurality of communication paths.

7. The computer implemented method of claim 4, further comprising:
ordering the progression list based on a cost associated with using a communication paths in the plurality of communication paths.

8. The computer implemented method of claim 4, further comprising:
establishing a log of messaging transaction performed between the first electronic device and the second electronic device, wherein the log reflects the frequency that each communication path in the plurality of communication paths is used to perform messaging transactions between the first electronic device and the second electronic device; and
ordering the progression list is defined based on the frequency.

9. The computer implemented method of claim 4, wherein the progression list includes a voice communication path, and wherein, upon, reaching the voice communication path in the progression list,
receiving an instruction to initiate a voice communication session between the first electronic device and the second electronic device.

10. The computer-implemented method of claim 9, wherein the voice communication path is selected from among a group consisting of a cellular communication path, a voice over Internet protocol (VoIP) communication path, and an audio-visual communication path.

11. The computer-implemented method of claim 1, further comprising:
receiving an instruction to search one or more network platforms for an account associated with a user of the second electronic device; and
upon discovery of a network platform with an account associated with a user of the second electronic device, adding a communication path associated with the network platform to the user record.

12. The computer-implemented method of claim 1, wherein receiving an indication that a response to the message has not been received from the second electronic device comprises determining that a response is not received within a predetermined threshold time period.

13. The computer-implemented method of claim 1, further comprising:
receiving an instruction to list prior messaging transactions between the first electronic device and the second electronic device; and
displaying a prior messaging transactions along with an indication of whether a user of the second electronic device responded to the prior messaging transactions.

14. An electronic device for of exchanging messages between users comprising:
a processor;
a network interface; and
a messaging module configured to control the processor to:
transmit a message over a first communication path from the electronic device to a second electronic device;
receive an indication that a response to the message has not been received from the second electronic device;
identify one or more additional communication paths from the first electronic device to the second electronic device; and
re-transmit the message over an additional communication path.

15. The system of claim 14, wherein the messaging module is configured to control the processor to identify the additional communication path by accessing a user record on the first electronic device for a user associated with the second electronic device.

16. The system of claim 14, wherein the messaging module is configured to control the processor send an additional method via each communication path in the plurality of additional communication paths.

17. The system of claim 14, wherein the messaging module is configured to control the processor to serially re-transmit the message to over the one or more additional communication paths according to a progression list until a response is received.

18. A non-transitory computer-readable storage medium comprising:
a medium configured to store computer-readable instructions thereon; and
the computer-readable instructions that, when executed by a processing device cause the processing device to perform a method, comprising:
transmitting a message over a first communication path from a first electronic device to a second electronic device;
receiving an indication that a response to the message has not been received from the second electronic device;
identifying one or more additional communication paths from the first electronic device to the second electronic device; and
re-transmitting the message over an additional communication path.

19. The non-transitory computer-readable storage medium of claim 18, and the instructions further causing the processing device to perform the steps of:
identifying the additional communication path by accessing a user record on the first electronic device for a user associated with the second electronic device.

20. The non-transitory computer-readable storage medium of claim 18, and the instructions further causing the processing device to perform the steps of:
sending an additional method via each communication path in the plurality of additional communication paths.

21. The non-transitory computer-readable storage medium of claim 18, and the instructions further causing the processing device to perform the steps of:
serially re-transmitting the message to over the one or more additional communication paths according to a progression list until a response is received.
